(19) United States
(12) Patent Application Publication
(10) Pub. No.: US 2026/0141391 A1
(43) Pub. Date: May 21, 2026

(54) METHODS AND SYSTEMS TO IDENTIFY FRAUD

(71) Applicant: MASTERCARD INTERNATIONAL INCORPORATED, Purchase, NY (US)

(72) Inventors: Kaushal Shetty, O'Fallon, MO (US); Devanshu Bhardwaj, Hisar (IN); Priya Kadam, O'Fallon, MO (US)

(73) Assignee: MASTERCARD INTERNATIONAL INCORPORATED, Purchase, NY (US)

(21) Appl. No.: 18/953,039

(22) Filed: Nov. 19, 2024

(51) Int. Cl. G06Q 20/40; G06N 20/00

(52) U.S. Cl. CPC G06Q 20/4016; G06N 20/00

(57) ABSTRACT

A system and method for training a machine learning model for fraud detection involves collecting and preparing data, performing variable calculations, selecting a classification machine learning model, and training algorithms of the selected model using labeled data to discern one or more patterns between input features and one or more target variables (fraud/no fraud decisions). Trained model artifacts are generated, encapsulating learned patterns and relationships from the training data. Additionally, the system and method are used to identify one or more fraudulent behavior patterns within large transaction datasets, generate an age confidence score based on these patterns, and predict fraudulent activities based on the age confidence score, enabling tailored support for system users.

### FIELD

The present invention relates to data collection for machine learning model training, and in particular to the integration of the machine learning model with existing transaction processing pipelines. The present invention has application in payment card networks, including network-based methods and systems for providing fraud risk detection and resource alignment in connection with payment card transactions.

### BACKGROUND

The elderly are increasingly becoming prime targets for financial fraud due to their considerable wealth and susceptibility to certain scams. This issue is further compounded by the rapidly evolving technological landscape, which creates disparities in exposure to payment-related technologies across different age groups. Introducing new technologies to older individuals later in life only serves to heighten their vulnerability to scams tailored to exploit those specific technologies. Moreover, nuanced factors such as prior technology exposure, geographical hotspots for fraudulent activities, and a history of low fraudulent transactions all contribute to the complexity of the problem. It is imperative to address these multifaceted challenges by implementing artificial intelligence (AI)-driven checks and criteria that financial institutions and other organizations can employ to fortify customer support measures.

Notably, the concentration of wealth in individuals aged 50 and above in the United States, accounting for approximately 83% of total wealth, renders them particularly susceptible to financial exploitation. The repercussions of elder financial abuse are staggering, with estimated losses ranging from approximately $2.9 billion to approximately $36 billion in 2016 alone.

Many types of fraud, including tech support scams and business imposters, disproportionately target the elderly demographic. Their level of exposure to financial technology throughout their lives influences their susceptibility to fraudulent activities, with variations observed across different age cohorts. The proposed criteria, encompassing factors such as past technology engagement, geographical location, and transaction history, serve as tools for financial institutions to prioritize customer support and allocate resources accordingly. Thus, there is a need for implementing improved fraud identification systems and methods by leveraging these insights so that institutions, for example, can better safeguard the aging population against financial exploitation and fraud.

### SUMMARY OF INVENTION

Fraud identification techniques are pivotal in addressing the susceptibility of the aging population to financial fraud. By analyzing transaction patterns and behaviors, these systems can pinpoint anomalies that may indicate fraudulent activity, particularly for elderly individuals whose financial behavior tends to be stable and predictable. Advanced AI algorithms can be instrumental in detecting one or more patterns indicative of fraud, adapting to new tactics used by scammers targeting the elderly. Such patterns may be subtle patterns that exist amidst a vast array of transaction data. Geolocation analysis allows for the identification of hotspots for fraudulent activity, enabling institutions to implement additional verification measures or block suspicious transactions originating from these areas. Detailed customer profiling based on transaction history, demographics, and risk factors facilitates targeted fraud detection, while real-time monitoring systems enable prompt intervention to prevent further financial losses. Moreover, leveraging fraud identification techniques for educational purposes can empower elderly customers to recognize common scams and protect themselves from financial exploitation. Overall, these techniques enable financial institutions to proactively detect and prevent fraud, safeguarding the financial well-being of elderly customers and preserving trust in the banking system.

These together with additional objects, features and advantages of the systems and methods of fraud identification will be readily apparent to those of ordinary skill in the art upon reading the following detailed description of the presently preferred, but nonetheless illustrative, embodiments when taken in conjunction with the accompanying drawings.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a graph illustrating a cognitive age and exposure to financial technology in accordance with some embodiments.

FIG. 2 is a schematic diagram illustrating an exemplary multi-party card industry system for enabling ordinary payment-card transactions.

FIG. 3 is a simplified block diagram of an exemplary payment account card system in accordance with one embodiment of the present invention.

FIG. 4 is an expanded block diagram of an exemplary embodiment of a server architecture of a payment account card system in accordance with one embodiment of the present invention.

FIG. 5 illustrates an exemplary configuration of a cardholder computer device operated by a cardholder.

FIG. 6 illustrates an exemplary configuration of a server computer device such as the sever system shown in FIGS. 3 and 4.

FIG. 7 is an illustration of a high-level block diagram of the computing device of the fraud identification system in accordance with some embodiments.

FIG. 8 is a simplified data flow block diagram of an exemplary fraud detection system in accordance with one embodiment of the present invention that may be used with the machine learning payment card system interchange network shown in FIGS. 3 and 4.

FIG. 9 is an illustration of a diagram showing location ranking for payment fraud in accordance with some embodiments.

FIG. 10 is a high-level block diagram illustrating machine learning model training in accordance with some embodiments.

FIG. 11 is a high-level block diagram illustrating machine learning model inference in accordance with some embodiments.

FIG. 12A is a flowchart illustrating a method, according to some embodiments of the present disclosure.

FIG. 12B is a flowchart extending from FIG. 12A and further illustrating the method, according to some embodiments of the present disclosure.

### DETAILED DESCRIPTION

The present disclosure includes many aspects and features. Moreover, while many aspects and features relate to, and are described in, the context of a network-based payment card system, embodiments of the present disclosure are not limited to use only in this context. The present disclosure can be understood more readily by reference to the following detailed description of the disclosure and the examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

As used throughout, the terms “confidence score” and “age confidence score” shall be used interchangeably and shall be understood to have the same meaning and scope. Additionally, while “age” is included in the term “age confidence score” it should not be construed to be necessarily limiting. The age-based benefits and advantages of numerous embodiments disclosed herein are features of some embodiments, but the benefits and advantages of such and other embodiments also have application independent of age.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Further Disclosure with Reference to Drawings

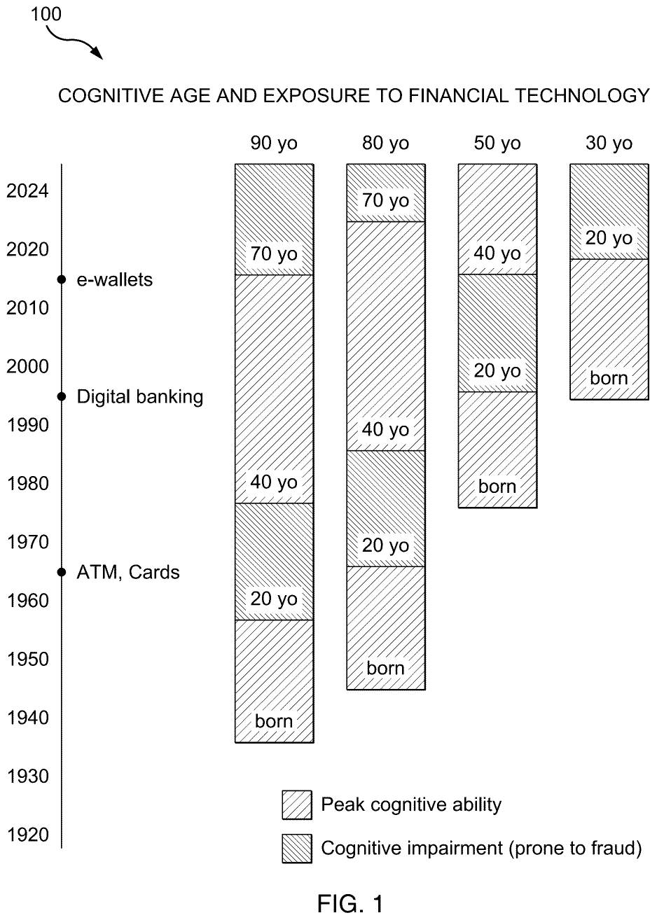

With reference now to the drawings, and in particular FIGS. 1-12B, the figures set forth herein illustrate exemplary methods and processes to implement a system configured to utilize various factors such as individuals' familiarity with financial technology, their age, and other specific details to categorize and prioritize customer support within financial institutions. This includes evaluating a person's past experience with technology, pinpointing areas prone to fraud based on location, and reviewing the user's (e.g., cardholder's) history of fraudulent activities. For example, individuals who have been introduced to new technologies later in life may be more vulnerable to certain types of fraud. By employing AI-driven checks, institutions can mitigate such risks. Armed with this insight, financial institutions can customize their support services accordingly, providing face-to-face assistance to older individuals (e.g., those in their 90s) while enhancing online user interfaces for younger demographics (e.g., individuals in their 30s).

In FIG. 1, the graph illustrates the correlation between peak cognitive ability, cognitive impairment, and susceptibility to fraud, demonstrating how embodiments of this system aim to allocate resources effectively according to these identified criteria.

FIG. 1 illustrates a graph 100 illustrating a cognitive age and exposure to financial technology in accordance with some embodiments. The graph presented correlates peak cognitive ability, cognitive impairment, and susceptibility to fraud, illustrating embodiments of the system's strategy to efficiently allocate resources based on these criteria. By incorporating various nuances such as a person's past exposure to technology, specific fraud hotspots based on location, and the user's history of fraudulent transactions, checks can be implemented using AI to prevent fraud. For instance, individuals with a history of minimal fraudulent activity are less likely to fall victim to scams, as scammers often target those with a known susceptibility. Financial and other institutions can utilize these criteria to prioritize and tailor customer support services. For example, offering in-person assistance for older demographics (e.g., 90-year-olds) who may be more vulnerable due to cognitive decline, while enhancing online user experiences for younger demographics (e.g., 30-year-olds). This approach ensures that resources are allocated effectively to address the specific needs and vulnerabilities of different customers and customer segments.

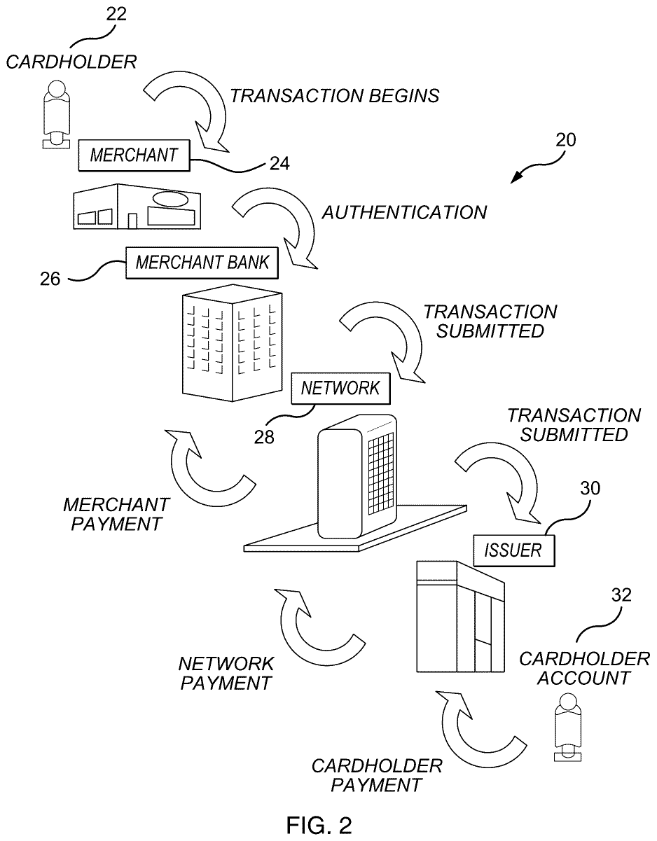

FIG. 2 is a schematic diagram illustrating an exemplary multi-party payment card system 20 for enabling ordinary payment-by-card transactions in which merchants and card issuers do not necessarily have a one-to-one relationship. The present invention relates to payment card system 20, such as a credit card payment system using the Mastercard® payment card system interchange network 28. Mastercard® payment card system interchange network 28 is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.). Although described as being a Mastercard® proprietary network, payment card system interchange network 28 may be associated, owned, and/or operated by any other entity as well.

In payment card system 20, a financial institution such as an issuer 30 issues a payment account card, such as a credit card account or a debit card account, to a cardholder 22, who uses the payment account card to tender payment for a purchase from a merchant 24. To accept payment with the payment account card, merchant 24 must normally establish an account with a financial institution that is part of the financial payment system. This financial institution generally provides financial services (e.g., underwriting, loan services, private equity, etc.) to large corporate entities and such similar entities, although they can have retail and commercial divisions. The financial institution is commonly referred to as a “merchant bank” or the “acquiring bank” or “acquirer bank” or simply “acquirer.” When a cardholder 22 tenders payment for a purchase with a payment account card, sometimes referred to as a financial transaction card, merchant 24 requests authorization from acquirer 26 for the amount of the purchase. The request may be performed over the telephone, but is usually performed through the use of a point-of-sale terminal, which reads the cardholder's account information from the magnetic stripe or other means on the payment account card and communicates electronically with the transaction processing computers of acquirer 26. Alternatively, acquirer 26 may authorize a third party to perform transaction processing on its behalf. In this case, the point-of-sale terminal will be configured to communicate with the third party. Such a third party is usually called a “merchant processor” or an “acquiring processor.”

Using payment card system interchange network 28, the computers of acquirer 26 or the merchant processor will communicate with the computers of issuer 30 to determine whether the cardholder's account is in good standing and whether the purchase is covered by the cardholder's available credit line, credit limit, or account balance. Based on these determinations, the request for authorization will be declined or accepted. If the request is accepted, an authorization code is issued to merchant 24.

When a request for authorization is accepted, the available credit line, credit limit, or available balance of cardholder's account 32 is adjusted (e.g., decreased). Normally, a charge is not posted immediately to a cardholder's account because bankcard associations, such as Mastercard International Incorporated®, have promulgated rules that do not allow a merchant to charge, or “capture,” until certain events associated with a transaction occur (e.g., goods are shipped or services are delivered). When a merchant ships or delivers the goods or services, merchant 24 captures the transaction by, for example, appropriate data entry procedures on the point-of-sale terminal. If a cardholder cancels a transaction before it is captured, a “void” is generated. If a cardholder returns goods after the transaction has been captured, a “credit” is generated.

For debit card transactions, when a request for a PIN authorization is approved by the issuer, the cardholder's account 32 is adjusted (e.g., decreased). Ordinarily, a charge is posted immediately to cardholder's account 32. The bankcard association then transmits the approval to the acquiring processor for distribution of goods/services, or information or cash disbursement in the event of an automatic teller machine (ATM) transaction.

After a transaction is captured, the transaction is settled between merchant 24, acquirer 26, and issuer 30. Settlement refers to the transfer of financial data or funds between the merchant's account, acquirer 26, and issuer 30 related to the transaction. Usually, transactions are captured and accumulated into a “batch,” which is settled as a group.

Financial transaction cards or payment account cards can refer to credit cards, debit cards, charge cards, and prepaid cards. These cards can all be used as a method of payment for performing a transaction. As described herein, the term “financial transaction card” or “payment account card” includes cards such as credit cards, debit cards, charge cards, and prepaid cards, but also includes any other devices that may hold payment account information, such as mobile phones, tablet computers, mobile devices containing digital wallets, personal digital assistants (PDAs), and key fobs.

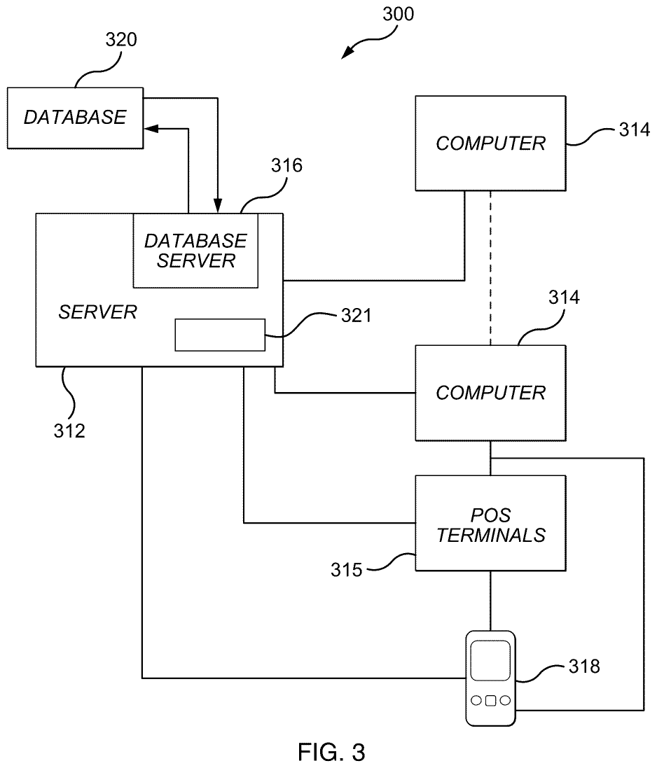

FIG. 3 is a simplified block diagram of an exemplary payment account card system 300 in accordance with one embodiment of the present invention. System 300 is a payment account card system, which can be utilized by account holders as part of a process of initiating a transaction authorization request and performing a transaction as described in greater detail below.

Specifically, in the example embodiment, system 300 includes a server system 312, which is a type of computer system, and a plurality of client sub-systems (also referred to as client systems 314) connected to server system 312. In one embodiment, client systems 314 are computers including a web browser, such that server system 312 is accessible to client systems 314 using the Internet. Client systems 314 are interconnected to the Internet through many interfaces including a network, such as a local area network (LAN) or a wide area network (WAN), dial-in-connections, cable modems, and special high-speed Integrated Services Digital Network (ISDN) lines. Client systems 314 could be any device capable of interconnecting to the Internet including a web-based phone, cellular device, computer tablet, PDA, or other web-based connectable equipment.

System 300 also includes point-of-sale (POS) terminals 315, which are connected to client systems 314 and may be connected to server system 312. POS terminals 315 are interconnected to the Internet through many interfaces including a network, such as a local area network (LAN) or a wide area network (WAN), dial-in-connections, cable modems, wireless modems, and special high-speed ISDN lines. POS terminals 315 could be any device capable of interconnecting to the Internet and including an input device capable of reading information from a cardholder's financial transaction card.

A database server 316 is connected to database 320, which contains information on a variety of matters, as described below in greater detail. In one embodiment, centralized database 320 is stored on server system 312 and can be accessed by cardholders at one of client systems 314 by logging onto server system 312 through one of client systems 314. In an alternative embodiment, database 320 is stored remotely from server system 312 and may be noncentralized. Database 320 may store transaction data generated as part of sales and purchase activities conducted over the bankcard network including data relating to merchants, account holders or customers, and purchases. Database 320 may also store account data including at least one of a cardholder name, a cardholder age, a cardholder primary and other addresses, an account number, and other account identifier. Database 320 may also store other account holder information specific or unique to an account holder, such as to create an account holder profile that may contain information concerning the account holder's prior usage of specific technologies (e.g., digital wallets, mobile payment applications, tap-to-pay methods, etc.), purchase patterns (e.g., purchase frequency, average spend per transaction, merchant, merchant location, merchant type, etc.), purchase trends, prior incidents of fraud victimization, and other similar information. Database 320 may also store information and data concerning reported, detected, and known fraudulent schemes and scams that are not necessarily associated with a cardholder, such that database 320 stores indicia of emerging, newly-popular, current, rampant, and prevalent scams, predatory schemes, and fraudulent activities. Database 320 may also store merchant data including a merchant identifier that identifies each merchant registered to use the payment account card network, and instructions for settling transactions including merchant bank account information. In one embodiment, an age confidence scoring service system 321 is stored on server system 312 and can be accessed by cardholders and others at one of client systems 314 by logging onto server system 312 through one of client systems 314. In embodiments, the information and data stored on database 320 can be dynamically collected and updated to database 320 in varying and selected periods such that, if desired, the database contains updated data and information in real time or near real time. Further, the data and information stored on database 320 can, in embodiments, be used by age confidence scoring service system 321 or server 312 to generate an age confidence score.

System 300 also includes at least one input device 318, which is configured to communicate with at least one of POS terminal 315, client systems 314 or server system 312. In the exemplary embodiment, input device 318 is associated with or controlled by a cardholder making a purchase using a payment account card and payment account card system 300. Input device 318 is interconnected to the Internet through many interfaces including a network, such as a local area network (LAN) or a wide area network (WAN), dial-in-connections, cable modems, wireless modems, and special high-speed ISDN lines. Input device 318 could be any device capable of interconnecting to the Internet including a web-based phone, personal digital assistant (PDA), or other web-based connectable equipment. Input device 318 is configured to communicate with POS terminal 315 using various outputs including, for example, Bluetooth communication, radio frequency communication, near field communication, network-based communication, and the like.

In the example embodiment, one of client systems 314 may be associated with acquirer 26 while another one of client systems 314 may be associated with an issuer 30, POS terminal 315 may be associated with merchant 24, input device 318 may be associated with cardholder 22, and server system 312 may be associated with payment card system interchange network 28.

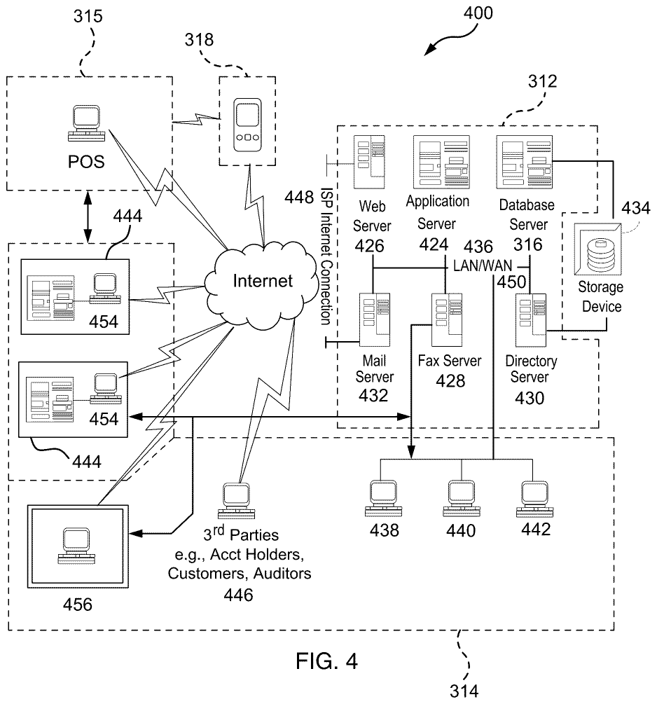

FIG. 4 is an expanded block diagram of an exemplary embodiment of a server architecture of a payment account card system 400 in accordance with one embodiment of the present invention. Components in system 400, identical to components of system 300 (shown in FIG. 3), are identified in FIG. 4 using the same reference numerals as used in FIG. 3. System 400 includes server system 312, client systems 314, POS terminals 315, and input devices 318. Server system 312 further includes database server 316, an application server 424 (i.e., a transaction server), a web server 426, a fax server 428, a directory server 430, and a mail server 432. A storage device 434 is coupled to database server 316 and directory server 430. Servers 316, 424, 426, 428, 430, and 432 are coupled in a local area network (LAN) 436. In addition, a system administrator workstation 438, a cardholder workstation 440, and a supervisor workstation 442 are coupled to LAN 436. Alternatively, workstations 438, 440, and 442 are coupled to LAN 436 using an Internet link or are connected through an Intranet.

Each workstation, 438, 440, and 442, is a personal computer having a web browser. Although the functions performed at the workstations typically are illustrated as being performed at respective workstations 438, 440, and 442, such functions can be performed at one of many personal computers coupled to LAN 436. Workstations 438, 440, and 442 are illustrated as being associated with separate functions only to facilitate an understanding of the different types of functions that can be performed by individuals having access to LAN 436.

Server system 312 is configured to be communicatively coupled to various individuals, including employees 444 and to third parties, e.g., account holders, customers, auditors, etc., 446 using an ISP Internet connection 448. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 450, local area network 436 could be used in place of WAN 450.

In the exemplary embodiment, any authorized individual having a workstation 454 can access system 400. At least one of the client systems includes a manager workstation 456 located at a remote location. Workstations 454 and 456 are personal computers having a web browser. Also, workstations 454 and 456 are configured to communicate with server system 312. Furthermore, fax server 428 communicates with remotely located client systems, including a client system 456 using a telephone link. Fax server 428 is configured to communicate with other client systems 438, 440, and 442 as well.

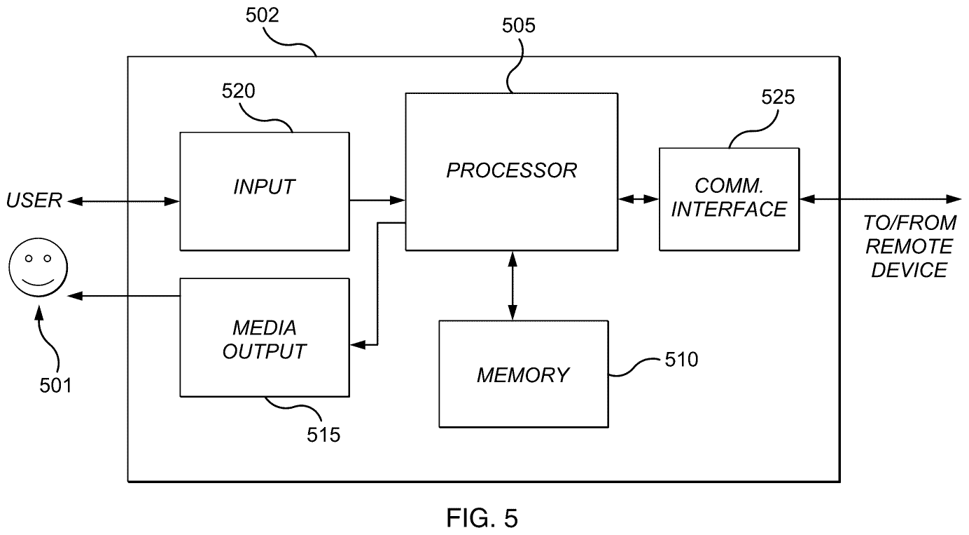

FIG. 5 illustrates an exemplary configuration of a cardholder computer device 502 operated by a cardholder 501. Cardholder computer device 502 may include, but is not limited to, client systems 314, 438, 440, and 442, POS terminal 315, input device 318, workstation 454, and manager workstation 456 (shown in FIG. 4).

Cardholder computer device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer readable media.

Cardholder computer device 502 also includes at least one media output component 515 for presenting information to cardholder 501. Media output component 515 is any component capable of conveying information to cardholder 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer device 502 includes an input device 520 for receiving input from cardholder 501. Input device 520 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 515 and input device 520.

Cardholder computer device 502 may also include a communication interface 525, which is communicatively couplable to a remote device such as server system 312. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer readable instructions for providing a user interface to cardholder 501 via media output component 515 and, optionally, receiving and processing input from input device 520. A user interface may include, among other possibilities, a web browser and client application. Web browsers enable cardholders, such as cardholder 501, to display and interact with media and other information typically embedded on a web page or a website from server system 312. A client application allows cardholder 501 to interact with a server application from server system 312.

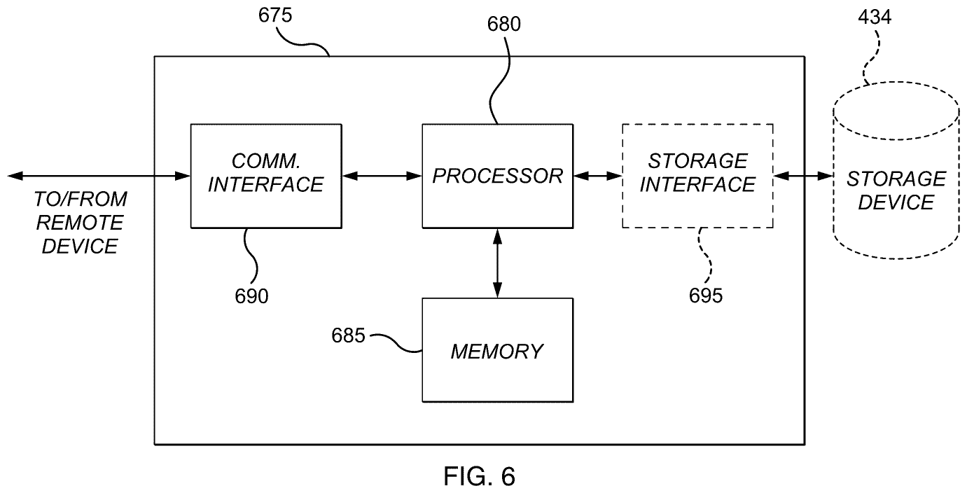

FIG. 6 illustrates an exemplary configuration of a server computer device 675 such as server system 312 (shown in FIGS. 3 and 4). Server computer device 675 may include, but is not limited to, database server 316, transaction server 424, web server 426, fax server 428, directory server 430, and mail server 432.

Server computer device 675 includes a processor 680 for executing instructions. Instructions may be stored in a memory area 685, for example. Processor 680 may include one or more processing units (e.g., in a multi-core configuration).

Processor 680 is operatively coupled to a communication interface 690 such that server computer device 675 is capable of communicating with a remote device such as cardholder computer device 502 or another server computer device 675. For example, communication interface 690 may receive requests from client systems 314 or input device 318 via the Internet, as illustrated in FIGS. 3 and 4.

Processor 680 may also be operatively coupled to a storage device 434. Storage device 434 is any computer operated hardware suitable for storing and/or retrieving data. In some embodiments, storage device 434 is integrated in server computer device 675. For example, server computer device 675 may include one or more hard disk drives as storage device 434. In other embodiments, storage device 434 is external to server computer device 675 and may be accessed by a plurality of server computer devices 675. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 680 is operatively coupled to storage device 434 via a storage interface 695. Storage interface 695 is any component capable of providing processor 680 with access to storage device 434. Storage interface 695 may include, for example, an Advanced Technology Attachment (ATA) adapter, a Serial ATA (SATA) adapter, a Small Computer System Interface (SCSI) adapter, a RAID controller, a storage area network (SAN) adapter, a network adapter, and/or any component providing processor 680 with access to storage device 434.

Memory areas 510 and 685 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

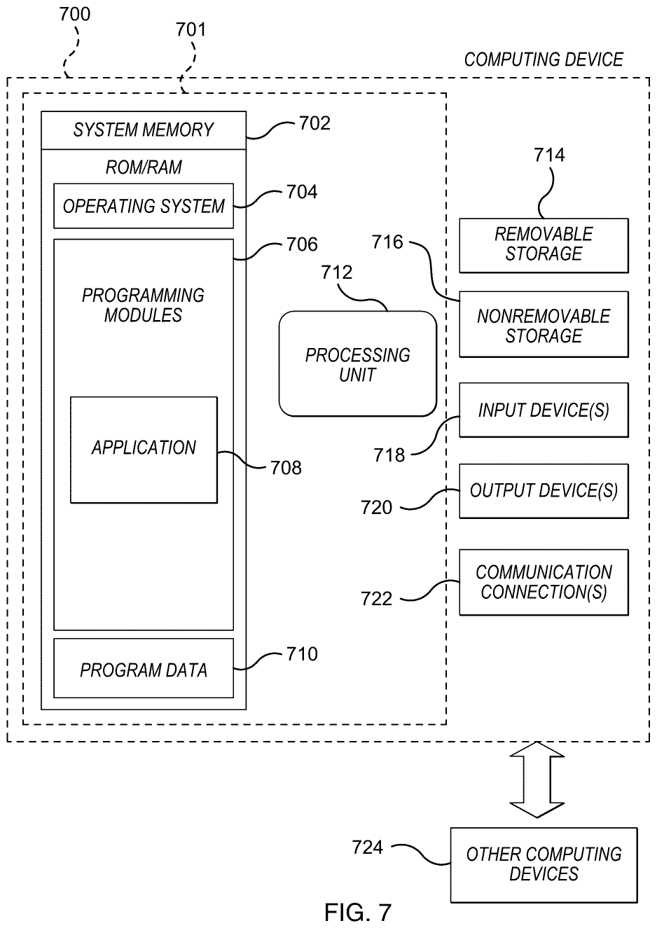

FIG. 7 is an illustration of a high-level block diagram of the computing device 700 of the fraud identification system in accordance with some embodiments. Computing device 700 illustrates another exemplary configuration of a server computer device, such as server system 312 (shown in FIGS. 3 and 4). The computing device 700 comprises an arrangement of interconnected components to facilitate computational tasks and interaction with users and external systems. It features a computing system 701 with system memory 702 composed of both volatile Random Access Memory (RAM) and non-volatile Read-Only Memory (ROM), housing firmware and operating system instructions for system initialization and operation. The operating system 704 orchestrates the utilization of hardware resources, managing memory, processes, and input/output operations. In one or more embodiments, the memory may be embodied as at least one of a Hard Disk Drive (HDD), a Solid State Drive (SSD), a USB Flash Drive, a SD Card (Secure Digital Card), a MicroSD Card, an External Hard Drive, an Optical Disc (CD/DVD/Blu-ray), a RAM (Random Access Memory), a NAS (Network Attached Storage), and a Cloud Storage. In one or more embodiments, the memory may be embodied as at least one of a memory circuit, wherein one or more memory circuits may be used as storage devices including one or more of DRAM, SRAM, EEPROM, Flash Memory, ROM, PROM, EPROM, NVRAM, MRAM, and FRAM.

In one or more embodiments, other elements comprise one or more of programming modules 706, including applications 708 tailored for specific functionalities, leverage the processing unit's capabilities to execute tasks efficiently. Program data 710, encompassing user-generated content and configuration information, resides in various storage mediums, including non-removable internal storage such as Solid State Drives (SSDs) and removable devices like USB flash drives. The processing unit (CPU) 712 serves as the computational powerhouse within the computing device 700. The terms processor and processing unit, as used throughout this disclosure, refer to central processing units, microprocessors, microcontrollers, reduced instruction set circuits (RISC), application specific integrated circuits (ASIC), logic circuits, and any other circuit or processor capable of executing the functions described herein. In embodiments, the CPU is integrated into the system architecture, interfacing with various components to execute instructions and perform tasks.

For example, the CPU communicates with system memory 702, including both RAM and ROM, to fetch instructions and data for processing. The operating system 704 manages this interaction, coordinating the flow of information between the CPU and system memory 702 to ensure efficient execution of programs and applications 708. Programming modules 706, including applications 708 and system utilities, utilize the CPU's processing capabilities to perform computational tasks. The CPU executes instructions encoded within these modules, performing arithmetic, logical, and control operations as directed by the software. Additionally, the CPU interfaces with storage devices, both non-removable storage 716 and removable storage 714, to read and write data as required by the software executing on the system. Input devices 718 provide the CPU with user-generated input, which the CPU processes and interprets to carry out corresponding actions. For example, input devices 718 such as keyboards and mice capture user input, while output devices 720 like monitors and printers present processed information. Output devices 720 receive signals from the CPU, presenting processed information to users in various forms. These devices may include displays, printers, speakers, and other peripherals.

Communication connections 722 in the computing device 700 enable interaction with external systems, networks, and peripherals. Wired connections, such as Ethernet, USB, HDMI, and Thunderbolt, provide reliable high-speed data transmission within local area networks (LANs) and across devices, facilitating tasks ranging from file transfer to multimedia playback. Wireless technologies like Wi-Fi, Bluetooth, NFC, and cellular networks offer flexible connectivity options, allowing devices to communicate without physical cables and providing internet access in diverse environments. Wi-Fi serves as a ubiquitous solution for wireless LAN connectivity, while Bluetooth facilitates short-range device pairing and data exchange. NFC enables contactless transactions and device interactions within close proximity, while cellular networks ensure internet connectivity on the go. These communication connections 722 empower the computing device 700 to exchange data, access network resources, and collaborate with other devices, enhancing productivity and facilitate application 708. Furthermore, bidirectional communication connections enable the CPU to interact with other computing devices 724 and systems, facilitating data exchange and collaborative workflows.

In implementations, a computing device, such as computing device 700, employs machine learning model training for fraud identification with a memory circuit storing computer executable instructions and a processing device, such as the CPU or a Graphics Processing Units (GPU), responsible for executing these instructions. Initially, the processing device collects data from various sources, including transaction records, user profiles, and historical fraud data. This data undergoes preparation processes to clean and normalize it, ensuring it is in a suitable format for analysis by handling missing values, scaling numerical features, and encoding categorical variables. The device then performs variable calculations, creating new input features essential for the model by applying complex mathematical transformations or aggregations to the raw data. Subsequently, it selects an appropriate classification machine learning model, such as logistic regression, decision trees, random forests, or neural networks, based on the best fit for fraud detection tasks. The processing device trains the selected model using labeled data where instances of fraud are marked, adjusting the model's parameters to minimize prediction errors and learn patterns distinguishing fraudulent from legitimate transactions. Once training is complete, the device generates trained model artifacts, including model weights, decision rules, and configuration files, encapsulating the learned knowledge. It then uses the trained model to identify patterns indicative of fraudulent behavior in new transaction data by applying the learned indicators to assess similarity to known fraud cases. Based on these patterns, the device generates an age confidence score, quantifying the risk associated with each transaction. Finally, using this score, the processing device predicts potentially fraudulent activities, flagging high-risk transactions for further investigation, thus ensuring real-time fraud detection and prevention and the ability to provide tailored support for the same.

As noted in embodiments herein, the computer executable instructions stored in the memory circuit of the fraud identification computing device comprise one or more algorithms and/or protocols, written in high-level programming languages such as Python, R, or C++. These instructions guide the processing device through various critical tasks. Initially, data collection instructions involve APIs and data connectors to securely and efficiently fetch data from diverse sources like databases, external APIs, or data lakes, ensuring robustness against network interruptions or data inconsistencies. Following this, data preparation instructions handle the cleaning, transformation, and normalization of data, including methods for dealing with missing values, normalizing numerical data, and encoding categorical variables. Variable calculation instructions generate new features from raw data through mathematical and statistical operations to facilitate model accuracy. The model selection instructions guide the processing device in choosing the most suitable machine learning model through cross-validation, hyperparameter tuning, and model comparison metrics, weighing options like logistic regression, decision trees, and neural networks. Model training instructions implement learning algorithms, adjusting model parameters to minimize prediction errors using techniques such as gradient descent or backpropagation. Upon completion of training, artifact generation instructions serialize the trained model, saving its parameters and configuration for future use.

Pattern encapsulation instructions ensure the learned patterns and relationships are embedded within the model, preserving the logic of feature transformations and the inference process. For real-time application, pattern identification instructions preprocess new transaction data and apply the trained model to detect patterns indicative of fraud. Based on these patterns, age confidence score generation instructions calculate a confidence level that quantifies the likelihood of fraud. Finally, fraud prediction instructions use this score to predict fraudulent activities, setting thresholds for classification and generating alerts for transactions deemed high-risk, integrating seamlessly with monitoring systems for further investigation. These instructions enable the processing device to effectively train, deploy, and utilize machine learning models for real-time fraud detection and prevention.

As noted in embodiments herein, a processing device is typically referred to as a processor and is responsible for executing instructions and performing calculations. It may include, but not be limited to, various types such as CPUs, which execute a sequence of stored instructions to perform arithmetic, logic, control, and input/output operations. A GPU may be employed in this system for rendering graphics, to excel at parallel processing, and to implement tasks involving large-scale computations like machine learning model training. Additionally, Application-Specific Integrated Circuits (ASICs) may also be implemented in this system and configured for tasks and optimized for performance. The processing device typically reads and interprets computer executable instructions stored in memory, managing complex computations and data flow within the system. Its performance may be influenced by factors including but not limited to, clock speed, number of cores, architecture, and/or instruction set efficiency, enabling it to handle a broad range of tasks from basic computing to advanced data processing and machine learning model training.

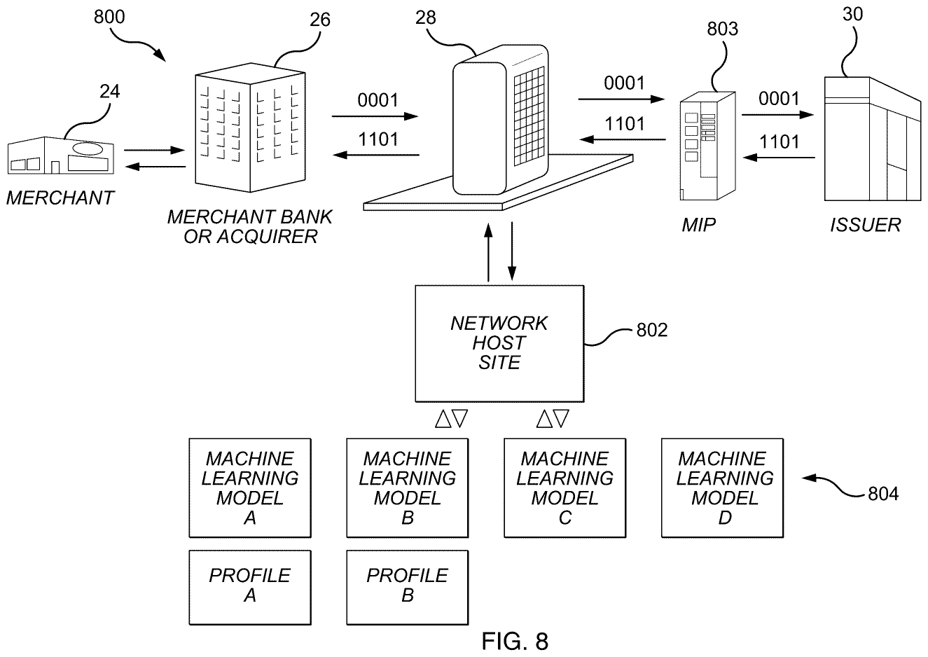

FIG. 8 is a simplified data flow block diagram of an exemplary fraud detection system 800 in accordance with one embodiment of the present invention that may be used with the payment account card systems shown in FIGS. 3 and 4. System 800 provides real-time fraud detection for merchants and issuers using machine learning modeling technology to provide participating acquirers, issuers, and merchants with a real-time confidence score for card transactions. In various embodiments, the real-time confidence score is a network-based score that measures the likelihood that the transaction on the associated card account is fraudulent. In various embodiments, the real-time confidence score is in part based on or is biased by the age or age group of the account holder. In the exemplary embodiment, fraud detection system 800 functions as part of a normal authorization of a transaction using payment card system interchange network 28. Specifically, a cardholder may seek to initiate a card transaction with merchant 24 in various ways. For example, the cardholder 22 can present the transaction card for checkout at the physical location of merchant 24, initiating a payment request that is submitted through POS terminal 315 (shown in FIG. 3) associated with merchant 24 (shown in FIG. 2) and/or through a merchant computer system. Alternatively, the cardholder 22 uses the transaction card to make any suitable transaction by, for example, entering account data into a merchant website. In this manner the location of the cardholder 22 may be different and removed from the transaction originator, i.e., the originator of the transaction authorization request message associated with the transaction, in this exemplary embodiment merchant 24. In this example, a transaction authorization request message is received from merchant 24 at payment card system interchange network 28 (through, for example, merchant bank 26), payment card system interchange network 28 determines whether acquirer or merchant 24 has subscribed to the confidence scoring service implemented by fraud detection system 800, if so payment card system interchange network 28 routes the transaction information to a network host site 802 that calculates a confidence score for the transaction associated with the received transaction authorization request, and sends the transaction authorization request to the issuer. In one embodiment, the confidence score is removed from the authorization at a MASTERCARD INTERFACE PROCESSOR™ or MIP™ 803 (trademarks of Mastercard International, Inc., of Purchase, N.Y.) such that the issuer does not receive the confidence score and determines authorization without using the confidence score. In various embodiments, the confidence score is transmitted to the issuer and the issuer uses the confidence score during the issuer authorization decision. The issuer then approves or denies the transaction authorization request. The score is appended to the response to the transaction authorization request that is forwarded from issuer 30 to merchant 24 through payment card system interchange network 28. The score can further be used by issuer 30 to classify and prioritize customer support resources for cardholders. Likewise, the score can be used by issuers to tailor support in light of one or more demographics, associations, or characteristics specific to a cardholder, such as age or location. In this manner, resources of issuer 30 can be efficiently and dynamically deployed, aligned, and adjusted. In a similar manner, the confidence score can be transmitted to merchant 24 by payment card system interchange network 28 or issuer 30 for use by merchant 24, for example to perform additional identity verification or other purposes consistent with the benefits of the present invention. In various embodiments, fraud detection system 800 is used primarily with card transactions where financial institutions seek to reduce the risk associated with age-based fraud and to improve the efficiency of its customer support and customer service functions.

In the exemplary embodiment, when the cardholder uses the transaction card to make each transaction, merchant 24 transmits a transaction authorization request from POS terminal 315 to server system 312, which is associated with payment card system interchange network 28 (shown in FIG. 2). The transaction authorization request includes the account number and transaction data representing the purchase made by the cardholder.

To determine the confidence score, network host site 802 uses at least one of a plurality of machine learning models 804. In implementations, each of the plurality of machine learning models 804 are based on Ensemble Trees, Decision Tree, Neural Network, Generalized Additive Model (GAM), Support Vector Machine (SVM), Discriminant Analysis, k-Nearest Neighbor (KNN), Gaussian Process Regression (GPR), Nonlinear Regression, Linear Regression, Generalized Linear Model (GLM), or Naive Bayes model types, or other classification or regression model types.

In embodiments, each model uses a payment card account profile associated with the payment card account used in the transaction. The payment card account profile includes information about the cardholder, historical transaction information for that payment card account, and long-term variables. The amount and type of historical transaction information used in each case is selectable based on a variety of factors, including the desire to detect and protect against a particular type of fraudulent transactions (e.g., age-focused fraud).

The payment card account profile contains long-term variables which collect the spending behavior for each individual card account for card transactions over a predetermined and selectable time period, for example, a trailing 24-month time period. Such period may alternatively be for an indeterminate period, such as for the life of the payment card. The payment card account profile can also contain or be associated with real time data, information, events or circumstances (for example, a technology type used in a particular transaction) such that the fraud detection system is capable of analyzing and determining a confidence score for a cardholder. The payment card account profile (including its long-term variables and/or real time data), alone or along with other information, is used by machine learning model algorithms to calculate the confidence score on card transactions effected on the identified card account.

In embodiments, the long-term variables are flexible and can be modified, added or removed from the machine learning model without having to rebuild the model. The long-term variables may be collected offline and updated to the machine learning model at regular intervals, including intervals that are near real-time. It should be understood that the long-term variables may be external or integral to the learning model in embodiments.

In one embodiment, network host site 802 is a stand-alone system that may be located remotely from payment card system interchange network 28. In various embodiments, network host site 802 is a subsystem of payment card system interchange network 28 and may be co-located with payment card system interchange network 28 or located remotely from payment card system interchange network 28.

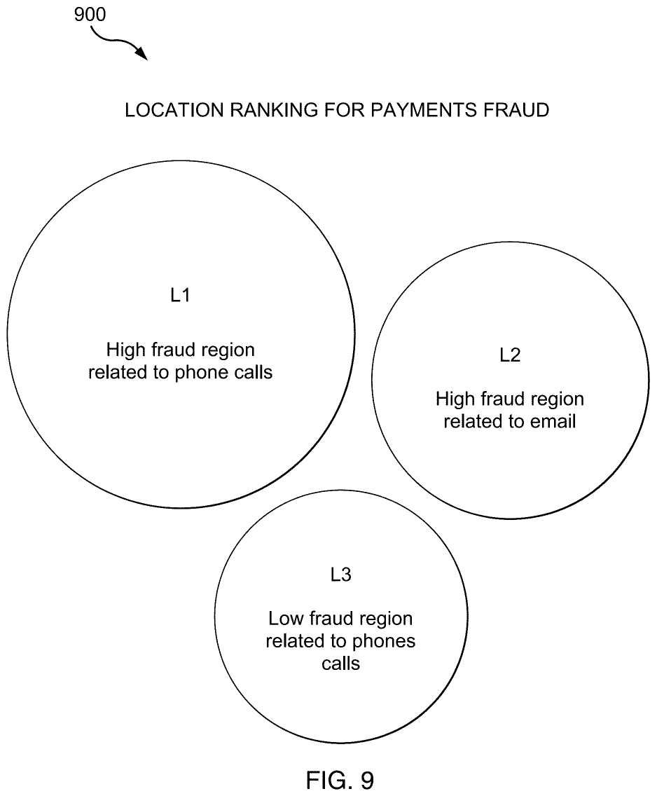

FIG. 9 is an illustration of a diagram 900 showing location ranking for payment fraud in accordance with some embodiments. The diagram provides a visual representation of the location ranking for payment fraud. Each region, labeled as L1, L2, and L3, is associated with varying degrees of fraud susceptibility and distinct methods of perpetration. L1 represents a high fraud region primarily linked to phone call scams. In this area, scammers frequently employ tactics such as phishing calls or impersonating legitimate entities over the phone to deceive individuals into revealing sensitive information or making unauthorized payments. For instance, fraudulent callers may pose as bank representatives and request personal banking details, leading to financial losses for unsuspecting victims. L2 denotes a high fraud region primarily associated with email scams. In this context, fraudsters commonly utilize email as a means to perpetrate fraudulent activities, such as phishing emails containing malicious links or attachments aimed at stealing login credentials or installing malware on recipients' devices. An example of this could be a deceptive email claiming to be from a reputable organization, prompting recipients to click on a link that redirects them to a fraudulent website designed to steal personal information. L3 signifies a low fraud region with a lesser prevalence of fraudulent activities related to phone calls. While fraud still occurs in this region, it is comparatively less frequent and typically involves less sophisticated tactics. Examples may include occasional unsolicited calls offering dubious products or services, but the overall risk of falling victim to phone call scams in this area is lower compared to regions classified as L1 or L2. Such regional categorization is not limited to low and high categorizations, but may include other categorizations, including, for example, and without limitation, extremely low, low, moderate, high, or extremely high categorizations. By categorizing regions based on their susceptibility to specific types of fraud and the prevalent methods used, financial institutions, such as issuer 30, and law enforcement agencies can prioritize resource allocation and implement targeted measures to mitigate fraud risks effectively in each region.

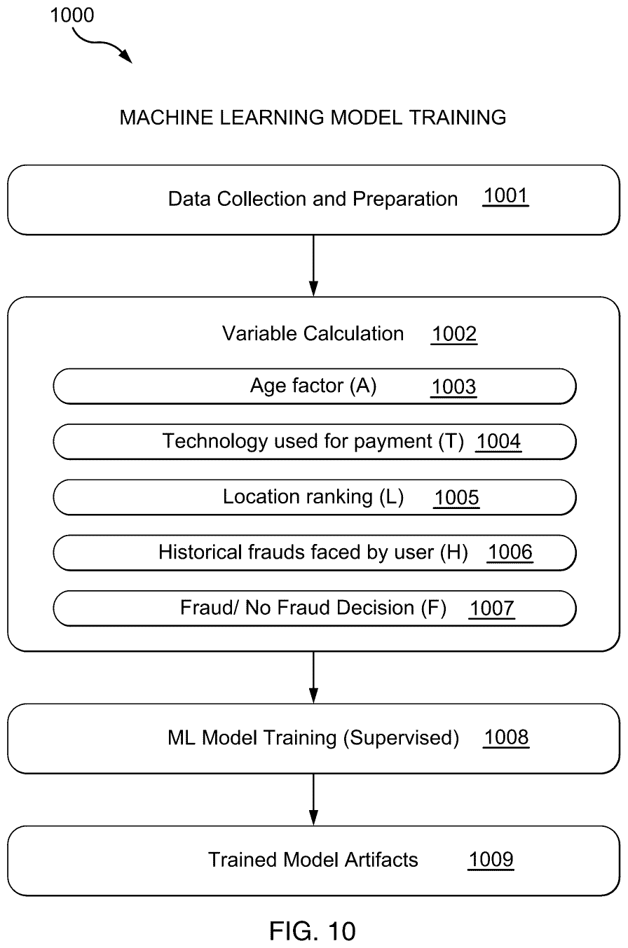

FIG. 10 is a high-level block diagram 1000 illustrating machine learning model training in accordance with some embodiments. In some embodiments, machine learning techniques determine and are used in mitigating fraud risks associated with payment card transactions. A processor, a processing element, or other functionality capable of carrying out the functions described herein may be trained using supervised or unsupervised machine learning, and/or the machine learning program may employ a neural network, which may be a convolutional neural network, a deep learning neural network, or a combined learning module or program that learns in two or more fields or areas of interest. Each of which, alone or in combination, capable of carrying out the machine learning functions described herein comprise exemplary implementations of a machine learning network. Such examples may be connected to, coupled with, networked with, or integrated with the network and systems illustrated in FIGS. 3 and 4 herein. Indeed, various elements set forth in FIGS. 3 through 7, for example system server 312 and database server 316, can be configured to comprise a machine learning network capable of carrying out the machine learning functions described in detail herein.

Machine learning may involve identifying and recognizing patterns in existing data in order to facilitate making predictions for subsequent data. Models may be created based upon example inputs in order to make valid and reliable predictions for novel inputs.

In the exemplary embodiment, the machine learning inputs are historical payment transactions performed by the cardholder. Additionally or alternatively, the machine learning programs may be trained by inputting sample data sets or certain data into the programs, such as images, user computing device data, location data, human behavioral data, technology type and characteristics, age-related data, activity data, consumption data, and/or other data that carries a positive, inverse, or other correlative relationship with fraud risks associated with payment card transactions. In embodiments, historical, periodic, and real-time transaction data from other cardholders may be used. The machine learning programs may also utilize deep learning algorithms that may be primarily focused on pattern recognition, and may be trained after processing multiple examples.

In some embodiments, the machine learning programs may include Bayesian Program Learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided, the processing element may, based upon the discovered rule, accurately predict the correct output. For example, cardholder-defined or issuer-defined variables may be input by the issuer or cardholder that defines and/or correlates with risk factors for various circumstances (e.g., transaction location, merchant identity, merchant demographic (e.g., high-end retail, fine jewelry, etc.), product/purchase type, etc.).

In unsupervised machine learning, the processing element may be required to find its own structure in unlabeled example inputs. In one embodiment, machine learning techniques may be used to extract data about the cardholder, other cardholders, merchant, user computing device, transaction details, geolocation information, image data, and/or other data. Based upon these analyses, the processing element may learn how to identify characteristics and patterns that may then be applied to analyzing fraudulent events, fraud risk data, and/or other data. For example, the processing element may learn, with proper permission or consent, to identify fraud risk factors and/or fraud risk probabilities applicable or related to a particular cardholder.

The machine learning model training process in some embodiments comprise several sequential steps, each playing a role in refining the model's predictive capabilities. The first step of the machine learning model training 1000 encompasses data collection and preparation 1001, where relevant datasets are gathered and organized to ensure consistency and suitability for analysis. For instance, financial transaction records, demographic information, and historical fraud instances are collated and formatted to facilitate subsequent analysis. Data collection and preparation 1001 form the cornerstone of effective machine learning model development, particularly in the context of fraud detection in financial institutions. Initially, data is sourced from multiple channels including transaction logs, customer databases, and external repositories such as credit bureaus. Subsequently, rigorous data cleaning processes are employed to rectify errors, handle missing values, and ensure uniformity in data formats. Feature engineering techniques are then applied to transform raw data into informative features that encapsulate relevant information for the model. For instance, demographic attributes like age may be segmented into categorical groups, while transaction data is aggregated to derive key features like transaction frequency and average amount. Categorical variables are encoded into numerical representations suitable for model training, and strategies to address class imbalance in fraud detection tasks are implemented. Finally, the dataset is partitioned into training, validation, and test sets to facilitate model training, tuning, and evaluation. Through meticulous data collection and preparation 1001, financial institutions can construct robust machine learning models capable of accurately detecting and mitigating fraudulent activities, thereby bolstering security measures.

The second step of the machine learning model training involves variable calculation 1002, which entails the computation of various factors essential for model training. Variable calculation 1002 is a step in the machine learning model training process, involving the computation of various factors that contribute to the predictive power of the model. Each implementation serves to capture specific aspects of the data and user behavior, enhancing the model's ability to discern patterns related to fraud. These factors encompass age 1003, reflecting the potential influence of age on susceptibility to fraud; technology utilized for payments 1004, delineating the usage of different payment methods and associated risks; location ranking 1005, indicating geographical variations in fraud prevalence; historical fraud incidents encountered by the user 1006, providing insights into past fraud patterns; and the binary fraud/no fraud decisions 1007, serving as the model's target variable. For example, a user's age could be quantified in years, while technology usage might be represented as categorical variables denoting different payment platforms. Further, age factor 1003 calculation involves quantifying the age of users, recognizing its potential influence on susceptibility to fraud. In another example, older individuals may be targeted due to perceived vulnerabilities or lack of familiarity with modern technology. The age factor 1003 indicates that as users grow older, they become increasingly susceptible to fraud. This relationship is quantified using the formula A=Yᵢ/(Yᵢ−Y_{b}), where Yᵢ represents the year of the transaction and b denotes the user's year of birth.

In implementations, the calculation of technology used for payment 1004 encompasses categorizing the payment methods employed by users, reflecting the diversity in payment platforms and associated risks. This could range from traditional methods like credit cards to emerging technologies such as mobile wallets, each carrying distinct security considerations. The technology used for payment 1004 is a factor in fraud susceptibility, with newer technologies posing higher risks due to security vulnerabilities and regulatory gaps. This relationship is modeled by T=(Yᵢ−Yₜᵢ)/(Yᵢ−Yₜ₁)+(Yᵢ−Yₜ₂)+ . . . +(Yᵢ−Yₜₙ), in which

$$T = ( {Y}_{i} - {Y}_{ti} ) / {\sum }_{j}^{n} ( {Y}_{i} - {Y}_{ti} ) ,$$

where Yᵢ represents the year of the transaction, Yₜ denotes the year when payment technologies were introduced, Yₜᵢ signifies the year in which the technology used for the transaction was introduced, and n represents the number of payment technologies.

Location ranking 1005 calculation assigns a ranking to geographic regions based on their prevalence of fraudulent activities, recognizing that fraud trends may vary across different locales. For instance, urban areas might be more susceptible to certain types of fraud compared to rural regions due to population density and infrastructure differences. Location ranking 1005 involves identifying specific geographic areas that are more susceptible to particular types of fraud compared to others. This is denoted by the equations L_{loc}=[Cₗₐₜ, C_{long}] where L_{loc} represents the location of the transaction, specified as a categorical variable, and Clat and Clong denote the latitudinal and longitudinal coordinates of the transaction, respectively. Additionally, the fraud ranking of the location for a particular technology (Lₜᵢ) is calculated as 1/Nₜᵢ, where Nₜᵢ represents the number of frauds reported for the i^{th} technology in the given location. This equation allows for the assessment of fraud susceptibility in different areas based on reported incidents related to specific technologies. For example, if a certain location consistently reports a high number of frauds associated with online transactions, its fraud ranking (Lₜᵢ) would be higher for online transactions compared to other technologies. This information can be instrumental in allocating resources for fraud prevention efforts and implementing targeted security measures in regions with elevated fraud risks.

Historical frauds faced by the user 1006 are calculated to assess the user's past encounters with fraudulent activities, providing valuable insights into recurring patterns or targeted tactics. The concept of historical frauds faced by a user 1006 suggests that individuals who have previously been victims of fraud are at an increased risk of experiencing fraudulent activities in the future. This relationship is articulated through a simple mathematical equation: H=1/F, where H denotes the historical frauds faced by the user 1006 and F represents the number of fraud incidents encountered. Essentially, the equation implies a direct relationship between historical frauds and future vulnerability to fraud. For instance, if a user has encountered multiple instances of fraud in the past (e.g., unauthorized transactions, identity theft), the likelihood of them falling victim to fraud again in subsequent transactions is higher. Conversely, individuals with a clean history of fraudulent incidents are presumed to have a lower susceptibility to fraud. This understanding underscores the importance of leveraging past fraud experiences as predictive indicators for identifying at-risk users and implementing targeted fraud prevention measures

In implementations, the process of determining whether a transaction is fraudulent or not, known as the fraud and no fraud decisions calculation, necessitates the assignment of a label to classify each transaction as either fraudulent or legitimate, essentially acting as a binary classifier. This label serves as a critical component in the training and evaluation of fraud detection models. The fraud and no fraud decisions calculation involves determining the binary outcome of whether a transaction or user activity constitutes fraud or not. These decisions serve as the target variable for the model, guiding its learning process towards accurately classifying future instances. By calculating these variables, the machine learning model gains a comprehensive understanding of user behavior and contextual factors, enabling more effective fraud detection and prevention strategies. For instance, in a supervised learning framework, historical transaction data is labeled based on whether fraud occurred or not. Transactions flagged as fraudulent may include instances of unauthorized charges, identity theft, or account takeovers, while legitimate transactions comprise routine purchases or bill payments. The binary classification enables the model to learn from past patterns and distinguish between typical user behavior and anomalous activities indicative of fraud. Moreover, the fraud and no fraud decisions calculation extends beyond model training to real-time transaction processing, where sophisticated algorithms analyze transaction characteristics, user behavior, and historical patterns to flag potentially fraudulent transactions for further investigation or intervention.

The third step of the machine learning model training entails supervised machine learning model training 1008, wherein algorithms are trained using labeled data to discern one or more patterns and relationships between input variables (features) and the one or more target variables (fraud/no fraud decisions). Various supervised learning algorithms, such as logistic regression or random forests, may be employed to iteratively adjust model parameters until optimal predictive performance is achieved. Supervised machine learning model training 1008 is a step in the development of the fraud detection system, involving the utilization of labeled data to enable the model to learn patterns and relationships between input variables and the target variable, which is typically the binary classification of fraud or non-fraud. During this process, various algorithms are employed to exploit the model parameters, aiming to optimize predictive performance. For example, logistic regression is commonly used in fraud detection due to its ability to model binary outcomes and provide probabilistic predictions. Decision trees and random forests are also popular choices, offering interpretability and the ability to capture complex interactions between features. The training data, comprising features derived from variables such as age, transaction history, and location, along with corresponding labels indicating fraud or non-fraud, is fed into the model, which then learns to distinguish fraudulent from legitimate transactions. Through iterative optimization techniques like gradient descent or cross-validation, the model refines its parameters to minimize prediction errors and maximize predictive accuracy. Moreover, techniques such as ensemble learning, where multiple models are combined to improve overall performance, are often employed to enhance the robustness and generalization capability of the fraud detection system. By undergoing supervised machine learning model training, the system gains the capability to accurately identify fraudulent activities while minimizing false positives.

Finally, in the fourth step of the machine learning model training, the trained model artifacts 1009 are generated, encapsulating the learned patterns and relationships derived during the training process. These artifacts may include model parameters, coefficients, or decision boundaries, which are essential for making predictions on new, unseen data. For instance, the trained model may produce decision boundaries separating instances classified as fraudulent from those deemed non-fraudulent, enabling real-time fraud detection and prevention in operational settings.

As noted, in at least one embodiment, trained model artifacts 1009 are components generated during the machine learning model training process, encapsulating learned patterns and relationships derived from the training data. These artifacts serve as the foundation for making predictions on new, unseen data and are instrumental in operationalizing the fraud detection system. Firstly, model parameters represent the coefficients and intercepts learned by the model during training, encapsulating the strength and direction of the relationships between input features and the target variable. For instance, in logistic regression, model parameters indicate the impact of each feature on the likelihood of a transaction being fraudulent. Decision boundaries, another artifact, delineate regions in the feature space where the model classifies transactions as fraudulent or non-fraudulent. These boundaries are particularly relevant for algorithms like support vector machines, which seek to maximize the margin between different classes. Additionally, feature importance scores provide insights into the relative importance of different features in influencing the model's predictions. By ranking features based on their contribution to predictive performance, financial institutions can prioritize resources and focus on mitigating high-risk factors. Model evaluation metrics, such as accuracy, precision, recall, and F1-score, assess the performance of the trained model on validation or test data, providing quantitative measures of its effectiveness in detecting fraudulent activities. Finally, model artifacts may include metadata documenting the training process, hyperparameters, and versioning information, facilitating reproducibility and model maintenance. By leveraging these trained model artifacts 1009, financial institutions can deploy robust fraud detection systems capable of accurately identifying and mitigating fraudulent transactions in real-time, thereby enhancing security measures and safeguarding against financial losses.

Further in implementations, in the process of selecting a classification machine learning model, the choice is informed by the individual performance of each model under consideration. Among these options, Extreme Gradient Boosting (XG Boost) emerges as a recommended choice, particularly valued for its exceptional performance in various contexts. XG Boost operates as a sequential ensemble of tree models, harnessing the collective strength of multiple decision trees to enhance predictive accuracy. Its versatility and robustness make it a popular choice across industries, including finance, healthcare, and e-commerce. For example, in fraud detection applications, XG Boost excels at identifying one or more patterns indicative of fraudulent behavior of at least a portion of transaction data, thereby enabling timely intervention and mitigation of risks. Such patterns indicative of fraudulent behavior may comprise a subtle pattern amidst vast volumes of transaction data. Additionally, its scalability and efficiency render it well-suited for handling large datasets and real-time processing requirements, ensuring rapid decision-making in dynamic environments. The utilization of XG Boost underscores a commitment to leveraging cutting-edge machine learning techniques to optimize performance and drive actionable insights, ultimately enhancing the effectiveness of fraud detection systems and delivering tangible benefits to stakeholders.

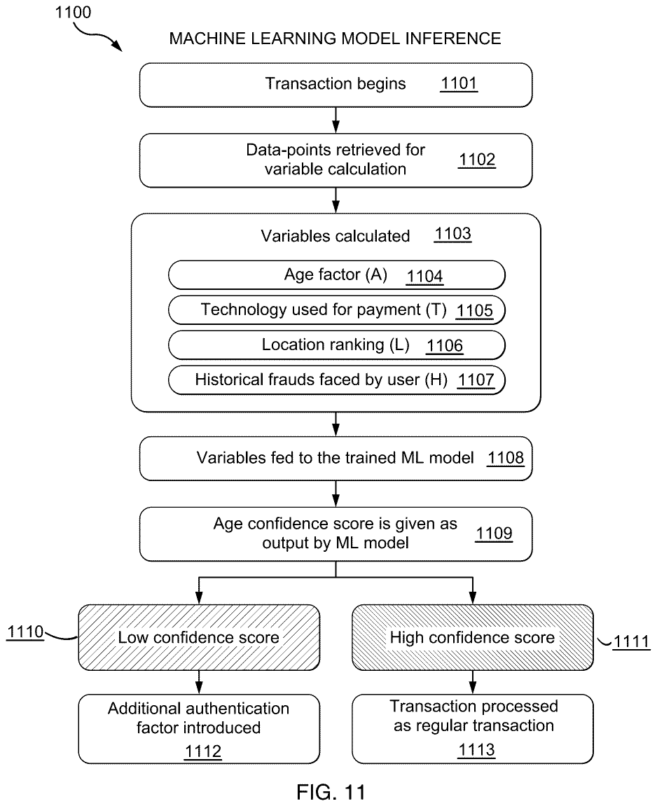

FIG. 11 is a high-level block diagram illustrating machine learning model inference 1100 in accordance with some embodiments. The machine learning model inference 1100 process initiates with a transaction being initiated 1101, marking the beginning of data processing to determine its legitimacy. Subsequently, relevant data points are retrieved 1102 to calculate variables 1103 crucial for fraud detection. These variables encompass the age factor 1104, reflecting the potential influence of user age on fraud susceptibility, along with considerations such as the technology used for payment 1105, location ranking 1106, and the user's historical encounters with fraud 1107. Once these variables are computed 1103, they are inputted into the trained machine learning model 1108, which then analyzes them to generate an age confidence score 1109. This score serves as an indicator of the model's certainty regarding the transaction's legitimacy. In cases where the confidence score is low 1110, signaling uncertainty, additional authentication measures may be required 1112 to verify the transaction's authenticity. For instance, the user might be prompted to provide a second form of verification, such as a one-time password or biometric authentication. Conversely, if the confidence score is high 1111, indicating a strong likelihood of legitimacy, the transaction can proceed as usual without the need for further scrutiny 1113.

In implementations, the integration of the solution incorporates the machine learning model into existing transaction processing pipelines through straightforward API calls, facilitating smooth interoperability and enhancing operational efficiency. To achieve this, both the machine learning model training and inference pipelines can be hosted on cloud platforms such as AWS SageMaker, Azure ML, or Google Cloud ML. By deploying the pipelines on the cloud, organizations gain access to robust infrastructure and resources, enabling efficient model training and real-time inference. Additionally, API endpoints are exposed to enable consumption of the model's predictions by both on-premises and cloud-based services. For instance, financial institutions can integrate the machine learning model into their transaction processing systems to automatically assess the risk associated with each transaction in real-time. This integration streamlines decision-making processes, enhances fraud detection capabilities, and enables proactive risk management across diverse transactional environments. Moreover, the flexibility afforded by cloud-based hosting ensures seamless scalability to accommodate fluctuating workloads and evolving business needs, thereby optimizing resource utilization and delivering superior performance in fraud detection and prevention efforts.

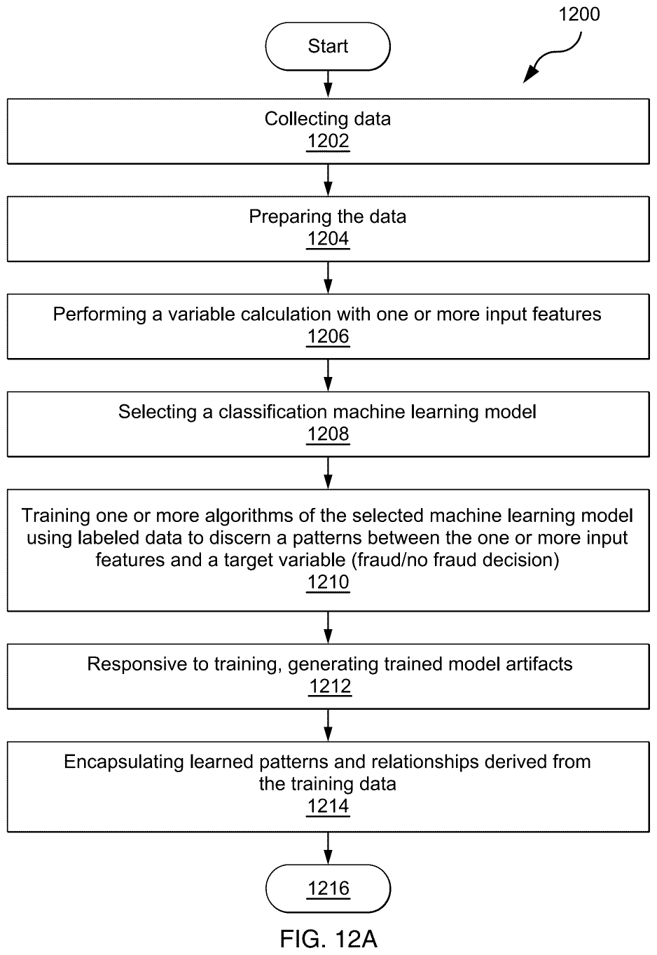

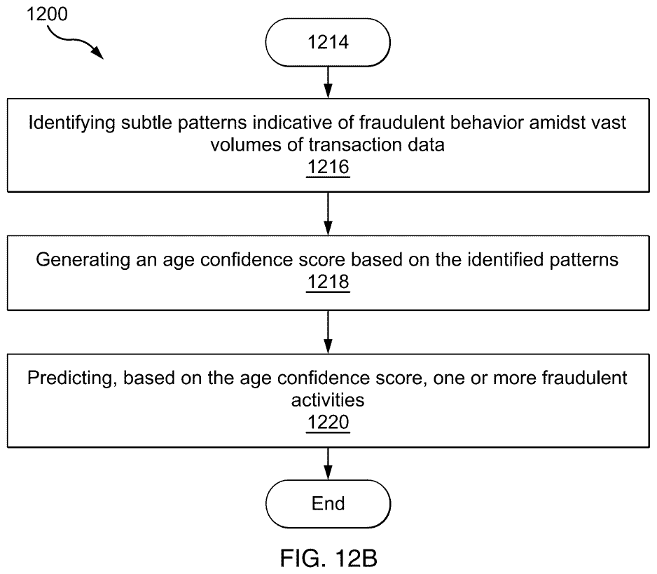

FIGS. 12A to 12B are flowcharts 1200 that describe a method for training a machine learning model for fraud detection, according to some embodiments of the present disclosure. In some embodiments, at block 1202, the method may include collecting data. At block 1204, the method may include preparing the data. At block 1206, the method may include performing a variable calculation with one or more input features. At block 1208, the method may include selecting a classification machine learning model. At block 1210, the method may include training one or more algorithms of the selected machine learning model using labeled data to discern one or more patterns between the one or more input features and one or more target variables (fraud/no fraud decisions).

In some embodiments, at block 1212, the method for training a machine learning model for fraud detection may include, responsive to training, generating trained model artifacts. At block 1214, the method may include encapsulating learned patterns and relationships derived from the training data. At block 1216, the method may include identifying one or more patterns indicative of fraudulent behavior amidst vast volumes of transaction data. At block 1218, the method may include generating an age confidence score based on the identified patterns. At block 1220, the method may include predicting, based on the age confidence score, one or more fraudulent activities.

In some embodiments, the one or more input features of the variable calculation include one or more age factors. In some embodiments, the one or more input features of the variable calculation include a type of technology used for a potential payment. In some embodiments, the one or more input features of the variable calculation include one or more location rankings. In some embodiments, the one or more input features of the variable calculation include a historical listing of one or more documented frauds by a user. In some embodiments, the target variable may include or be fraud/no fraud decisions.

With respect to the above description, it is to be realized that the optimum dimensional relationship for the various components of the invention described above and in the illustrations include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but are not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1-6. (canceled)

7. A computing device to implement machine learning model training for fraud identification, comprising:
a memory circuit storing computer executable instructions; and
a processing device, wherein execution of the computer executable instructions by the processing device, causes the processing device to:
collect data;
prepare the data;
perform a variable calculation with one or more input features;
determine one or more target variables based on the performed variable calculation with the one or more input features;
select a classification machine learning model;
train one or more algorithms of the selected machine learning model using labeled data to discern one or more patterns between the one or more input features and the one or more target variables;
responsive to training, generate trained model artifacts;
encapsulate learned patterns and relationships derived from the data;
identify one or more patterns indicative of fraudulent behavior of at least a portion of transaction data;
generate an age confidence score based on the identified one or more patterns; and
predict, based on the age confidence score, one or more fraudulent activities.

8-20. (canceled)

21. The computing device of claim 7, wherein execution of the computer executable instructions by the processing device further causes the processing device to:
receive, as part of the collected data, transaction information associated with a payment card transaction communicated via a payment card system interchange network prior to routing of a transaction authorization request to an issuer;
retrieve, based on the transaction information, a payment card account profile associated with the payment card transaction, the payment card account profile including cardholder information;
generate the age confidence score based at least in part on an age factor calculation derived from a birth year of the cardholder relative to a year of the transaction, a technology factor calculation associated with a payment technology used for the transaction, a location ranking calculation associated with a geographic location associated with the transaction, and a historical fraud factor associated with prior fraud experiences of the cardholder; and
use the age confidence score to predict the one or more fraudulent activities.

22. A method for providing real-time fraud detection, comprising:
receiving, at a payment card system interchange network, a transaction authorization request message for a transaction at a merchant made with a payment card, wherein the transaction authorization request message comprises transaction information associated with the transaction, wherein the transaction information comprises payment card details of the payment card associated with a cardholder;
determining that the merchant is subscribed to a confidence scoring service at the payment card system interchange network;
prior to routing the transaction authorization request message to an issuer, routing the transaction information to a network host site, wherein the network host site is a subsystem of the payment card system interchange network;
generating, at the network host site, a confidence score for the transaction based at least in part on an age factor calculation, a technology factor calculation, a location ranking calculation, and a historical fraud factor, wherein generating the confidence score for the transaction comprises:
retrieving a payment card account profile associated with the payment card details, wherein the payment card account profile comprises information about the cardholder associated with the payment card;
retrieving, from the payment card account profile, a birth year of the cardholder, where the birth year of the cardholder indicates an age above a threshold;
obtaining the age factor calculation including a ratio of the year of the transaction relative to the birth year of the cardholder;
obtaining the technology factor calculation based on data regarding a technology being used for the transaction authorization request; the year of the transaction authorization request; data regarding a payment technology being used; and a number reflecting one or more different types of payment technologies normally used by the cardholder;
obtaining the location ranking calculation based on latitude and longitude coordinates for a location associated with the transaction authorization request and a number of fraudulent transactions associated with that location; and
obtaining the historical fraud factor, representing a number of fraud experiences historically experienced by the cardholder; and
appending the confidence score to the transaction authorization request message;
sending the transaction authorization request message appended with the confidence score to an issuer associated with the payment card details; and
receiving, from the issuer, a decline to the transaction authorization request based in part on the confidence score due in part to the age factor calculation.

23. The method of claim 22, further comprising retrieving latitude and longitude coordinates for a location associated with the transaction request.

24. The method of claim 22, further comprising:
pulling historical fraud data of the cardholder, including a number of fraud incidents faced by the cardholder; and
calculating the historical fraud factor.

25. The method of claim 24, wherein the historical fraud factor calculation is based upon the formula (H=1/F), wherein F=number of fraud incidents faced by the cardholder.

26. The method of claim 22, further comprising:
determining, based on the transaction authorization request message, the location associated with the transaction authorization request;
retrieving, the latitude and longitude coordinates for the location; and
retrieving a fraud ranking of the location; and.

27. The method of claim 26, wherein the location ranking calculation is based upon the formula (Lloc=[Clat, Clong]; Lti=1/Nti), wherein Lloc=location of transaction, Clat=latitudinal coordinate of the location, Clong=longitudinal coordinate of the location, Lti=fraud ranking of the location for an ith technology, and Nti=number of frauds reported for ith technology in a given location.

28. The method of claim 22, wherein the age factor calculation is based upon the formula (A=Yi/(Yi−Yb) wherein, Yi=year of the transaction and Yb=the birth year of the cardholder.

29. The method of claim 22, wherein the generating, at the network host site, the confidence score for the transaction occurs by inferring at a neural network which is trained to identify patterns indicative of fraudulent behavior utilizing historic information of past transactions.

30. A system, comprising:
a processing unit;
a memory; and
instructions stored in the memory that, when executed by the processing unit, direct the processing unit to at least:
receive, at a payment card system interchange network, a transaction authorization request message for a transaction at a merchant made with a payment card, wherein the transaction authorization request message comprises transaction information associated with the transaction, wherein the transaction information comprises payment card details of the payment card associated with a cardholder;
determine that the merchant is subscribed to a confidence scoring service at the payment card system interchange network;
prior to routing the transaction authorization request message to an issuer, route the transaction information to a network host site, wherein the network host site is a subsystem of the payment card system interchange network;
generate, at the network host site, a confidence score for the transaction based at least in part on an age factor calculation, a technology factor calculation, a location ranking calculation, and a historical fraud factor, wherein generating the confidence score for the transaction comprises:
retrieve a payment card account profile associated with the payment card details, wherein the payment card account profile comprises information about the cardholder associated with the payment card;
retrieve, from the payment card account profile, a birth year of the cardholder, where the birth year of the cardholder indicates an age above a threshold;
obtain the age factor calculation including a ratio of the year of the transaction relative to the birth year of the cardholder;
obtain the technology factor calculation based on data regarding a technology being used for the transaction authorization request; the year of the transaction authorization request; data regarding a payment technology being used; and a number reflecting one or more different types of payment technologies normally used by the cardholder;
obtain the location ranking calculation based on latitude and longitude coordinates for a location associated with the transaction authorization request and a number of fraudulent transactions associated with that location; and
obtain the historical fraud factor, representing a number of fraud experiences historically experienced by the cardholder; and
append the confidence score to the transaction authorization request message;
send the transaction authorization request message appended with the confidence score to an issuer associated with the payment card details; and
receive, from the issuer, a decline to the transaction authorization request based in part on the confidence score due in part to the age factor calculation.

31. The system of claim 30, wherein the instructions further direct the processing unit to retrieve latitude and longitude coordinates for a location associated with the transaction request.

32. The system of claim 30, wherein the instructions further direct the processing unit to:
pull historical fraud data of the cardholder, including a number of fraud incidents faced by the cardholder; and
calculate the historical fraud factor.

33. The system of claim 32, wherein the historical fraud factor calculation is based upon the formula (H=1/F), wherein F=number of fraud incidents faced by the cardholder.

34. The system of claim 30, wherein the instructions further direct the processing unit to:
determine, based on the transaction authorization request message, the location associated with the transaction authorization request;
retrieve, the latitude and longitude coordinates for the location; and
retrieve a fraud ranking of the location; and.

35. The system of claim 34, wherein the location ranking calculation is based upon the formula (Lloc=[Clat, Clong]; Lti=1/Nti), wherein Lloc=location of transaction, Clat=latitudinal coordinate of the location, Clong=longitudinal coordinate of the location, Lti=fraud ranking of the location for an ith technology, and Nti=number of frauds reported for ith technology in a given location.

36. The system of claim 30, wherein the age factor calculation is based upon the formula (A=Yi/(Yi−Yb) wherein, Yi=year of the transaction and Yb=the birth year of the cardholder.

37. The system of claim 30, wherein the instructions that direct the processing unit to generate, at the network host site, the confidence score for the transaction comprise instructions that direct the processing unit to infer by a neural network which is trained to identify patterns indicative of fraudulent behavior utilizing historic information of past transactions.
